(19) United States
(12) Patent Application Publication
(10) Pub. No.: US 2007/0232380 A1
(43) Pub. Date: Oct. 4, 2007

(54) Gaming Machine Reel Shroud

(75) Inventor: John Vallejo, Las Vegas, NV (US)

Correspondence Address: BALLY GAMING INC., 6601 S. BERMUDA ROAD, LAS VEGAS, NV, 89119, US

(73) Assignee: Bally Gaming, Inc., Las Vegas, NV (US)

(21) Appl. No.: 11/530,795

(22) Filed: Sep. 11, 2006

Related U.S. Application Data
(60) Provisional application No. 60/715,774, filed on Sep. 10, 2005.

(51) Int. Cl. A63F 13/08

(52) U.S. Cl. 463/20

(57) ABSTRACT

A reel shroud apparatus and shrouding method are disclosed for use in gaming devices that display observable indicia on reels through one or more windows associated with the reels. The disclosed reel shroud apparatus and shrouding method offers reel illumination isolation techniques that may reduce splash. The reel shroud apparatus and shrouding method also discloses techniques to reduce structure and enable wider angle viewing of the reels.

### RELATED APPLICATIONS

This application claims priority from provisional application 60/715,774 filed on Sep. 10, 2005, hereby incorporated by reference.

### FIELD OF THE INVENTION

The field of this invention generally relates to game apparatuses and methods, and more particularly to shroud structures and methods used in conjunction with game apparatuses and methods.

### BACKGROUND OF THE RELATED ART

Game devices such as slot machines are well known and are in widespread usage throughout the world. The common form of various game devices is a cabinet with a plurality of rotating reels. In such devices, it is common for each reel to have a piece of material commonly known as a “reel strip” mounted about the reel periphery and upon which are displayed certain types of indicia such as representations of fruits (oranges, plums, lemons, cherries, etc.) arranged in particular patterns. The cabinet also commonly includes a door upon which is mounted a transparent plastic or glass barrier that physically separates the player from the reels. These barriers, generally known as “reel glass,” are normally screen printed with masking graphics that create rectangular viewing windows aligned horizontally in front of each reel to allow a player to observe an aligned sequence of the indicia located on the reels.

The forward edge of each reel mechanism is typically separated from the back face of the reel glass by distances of ¼ inch or more and it is common to be able to partially see the interior of the gaming machine cabinet and reel mechanisms through this space. It is desirable to mask the internal structure of the reels from observation by the player in order to prevent distraction from the game and for aesthetic and security reasons. One partial solution that has been proposed is to reduce the size of the viewing windows so that some portion of the face of each reel is also obscured. This masking approach has the undesired effect of creating viewing angle deficiencies at oblique angles to the outermost reels. This is most prevalent in cases where more than three reels are used, since reel widths are generally reduced in order to fit the increased number of reels in a cabinet of typical dimensions, thus increasing the percentage of the reel face obscured by masking graphics around each reel window. Inability to clearly see all of the displayed indicia can lead to player dissatisfaction or confusion, particularly in modern reel spinning slot machines that employ multiple pay lines.

As is well-known in the art, reels are generally front-lit. Some reel strips may be formed from an opaque material and cut-out in the area of certain semi-transparent indicia so that those indicia may be selectively back-lit by lights mounted to the reel assembly behind the reel strip. One of the problems associated with front-lit reel lighting is that it does not allow for the front-highlighting of a specific reel. This is generally because front-lit lighting readily bleeds or splashes from the one specific reel to the adjacent reels, which reduces the desired affect and can cause player confusion. One proposed partial solution is to provide light barriers mounted to the back of the reel glass or to the gaming machine door and extending back toward and between the reels. However, these barriers further contribute to the oblique angle viewing problems described above.

### SUMMARY OF THE INVENTION

In accordance with one aspect of the invention, a reel shroud apparatus and shrouding method are provided for use in gaming devices with mechanical reels that are rotatably driven for a certain period of time and then stopped with the reels then displaying a certain type of observable indicia through one or more windows associated with the reels. The reel shroud apparatus and shrouding method offers a reel illumination isolation technique reducing splash and reduced structure for wider angle viewing of the reels.

Further, objects, features and advantages of various embodiments of the invention will be apparent from the following detailed disclosure, taken in conjunction with the accompanying sheets of drawings.

### BRIEF DESCRIPTION OF THE DRAWINGS

FIG. 1 is a perspective view of a gaming machine incorporating one embodiment of the shroud assembly.

FIG. 2 is a front view of one embodiment of the shroud assembly.

FIG. 3 is a front view of one embodiment of the shroud assembly.

FIG. 4 is a three dimensional front view of one embodiment of the shroud assembly.

FIG. 5 is a three dimensional rear view of one embodiment of the shroud assembly.

FIG. 6 is a front view of one embodiment of the shroud assembly position in front of reels demonstrating an example of light locations illuminated to indicate particular pay lines.

### DETAILED DESCRIPTION OF THE PREFERRED EMBODIMENTS

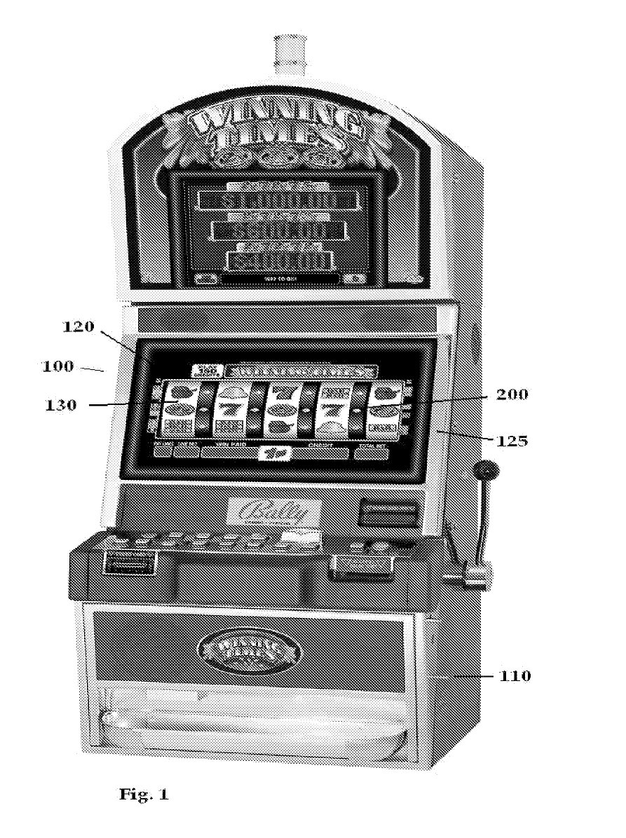

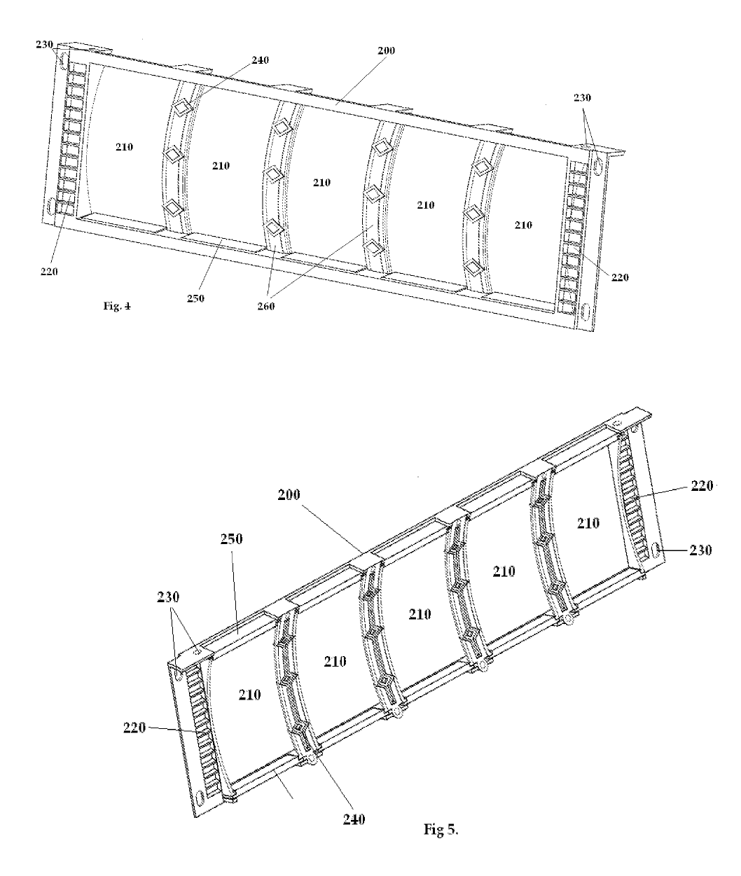

Referring now to the drawings, wherein like reference numerals denote like or corresponding parts throughout the drawings and, more particularly to FIGS. 1-5, a gaming machine 100, such as a conventional Bally Technologies gaming machine, is shown having a reel shroud 200. Referring now to FIG. 1, gaming machine 100 includes a cabinet 110 and reel shroud 200 connected to the reel glass 120 or directly to the door 125 of the cabinet 110 and positioned in front of the reels 130. It should also be appreciated that the reel shroud of the present invention could alternatively be attached to a support mounted to cabinet 110, such as an axis rod supporting the reels. Reel shroud 200 may be constructed, by way of example and not intended to be limiting in any way, from a plastic material that is cast, forged, pressure-formed or vacuum formed. In one embodiment, the shroud would be constructed out of a plastic material using an injection molding production process that allow the tight dimensional tolerances required to accommodate the overall tolerance stack-ups typical in the reel and cabinet assemblies . It should be appreciated that the shroud can be constructed of any suitable materials and any suitable forming methods may be employed, without limitation. In the embodiment shown in FIG. 1, reel shroud 200 has a dark external coloring matched to blend in with the background surrounding reels 130. The dark coloring of reel shroud 200 has a reduced glare and reflective texture or tint.

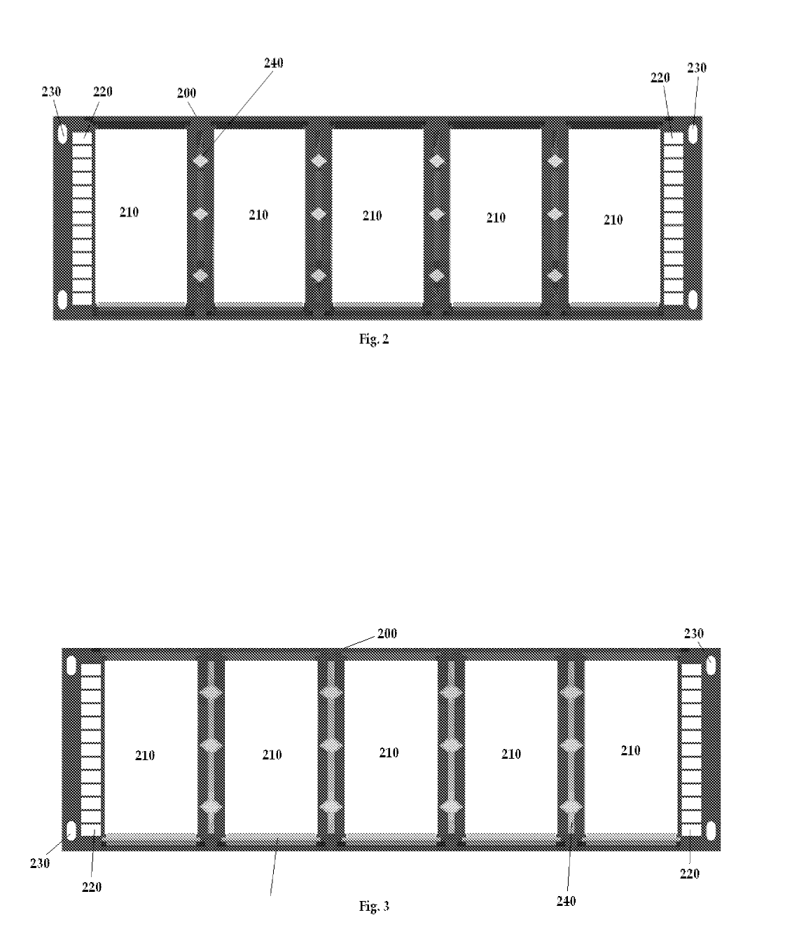

Referring now to FIGS. 2-5, using one or more mounting holes 230, shroud 200 may be secured to the gaming machine as generally described above with conventionally available or adaptable fasteners, connectors, and support structure. Alternatively, the forward portion of reel shroud 200 may be adhered to the back of reel glass 120 as by an adhesive glue or epoxy. In such case, the perimeter frame may have one or more portions, such as two vertical elements extending forward to the glass and the remainder of the forward surfaces of reel shroud 200 remain recessed away from the reel glass 120 and in proximity to respective of reels 120 providing an overall view and positioning of shroud 200 and reels 130 so that they appear to substantially be spatially integrated or have adjacent components in the same plane. Alternatively, more portions of reel shroud 130 may extend forward to reel glass 120, such as reel separator ribs 260, however this may introduce some obstruction to viewing reels 130 while having the benefit of reducing light splashing from a selected area to another. Another embodiment may have the entire perimeter region of reel shroud 200 extending forward with remaining forward surface areas being recessed.

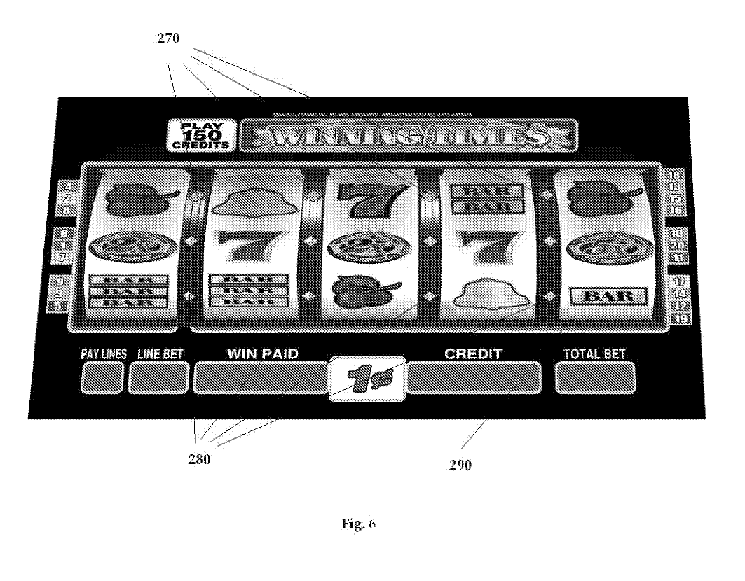

Reel shroud 200 contains one or more reel window openings 210 that closely surround the sides and top of each reel (shown in FIGS. 1 and 6). When mounted, reel shroud 200 masks view of the internal mechanism of reels 130. Additionally, the implementation of reel shroud 200 enables the transparent window opening 290 (FIG. 6) of reel glass that overlays reels 130 to be expanded into a single opening as shown that extends about the full size of the combined reel faces so as to provide the player with an unobstructed view of the displayed faces of each reel mechanism and their respective indicia. It will be obvious to those normally skilled in the art that other reel glass graphic variations are possible.

Referring to FIGS. 2 and 3, active pay line light openings 220 may be positioned in front of respective light sources, such as light emitting devices (LEDs), in order to allow light to illuminate a particular location of reel glass 120. For example, when a player places a wager on a particular pay line, the LED may operate and emit a light beam through associated pairs of light openings 220 corresponding to the particular pay line being wagered upon. Reel shroud 200 may also enable selective lighting to illuminate other locations of reel glass 120 through selective positioning of additional light sources on the backside of the shroud. Such lighting may be visible through clear or semi-transparent insets 240 (as shown in FIG. 2-4) and controlled by the game to provide feedback to the player during game play. Insets 240 may be comprised of plastic and may have various shapes and sizes and be of various shades and colors. By example, in some embodiments, certain lights may be illuminated in order to identify a particular pay line pattern as it is wagered or when a win occurs on that pay line. Briefly turning to FIG. 6, lights at positions 270 may be illuminated to indicate that the cherries on the top row of the first reel produced a winning combination on the pay line that extends across the top row of the reels. Similarly, lights at positions 280 may be illuminated to indicate that the triple-bar indicia on the bottom row of the first and second reels produced a winning combination on the pay line that extends across the bottom row of reels. As will be readily apparent to those normally skilled in the art, the various winning combinations may be so highlighted in a sequential or some other manner that clearly distinguishes one winning combination from another, with or without simultaneous back-lighting of the winning indicia.

The shroud lights (not shown) may consist of, for example and not intended to be limiting in any way, incandescent lamps, light-emitting diodes (LED's), colored LED's, tri-color LED's, black light lamps or LED's or any other similar and suitable illumination device.

Referring to FIG. 4, separator ribs 260 of the shroud 200 separate the reels from one another and may be curved as shown to match the curvature of the reels. This creates an aesthetically pleasing three-dimensional effect. It should be appreciated that, in alternate embodiments, the separators 260 may be of other shapes and appearance. The separator ribs 260, by extending from the front of the reels toward the back of the reel glass, may allow the reduction or complete elimination of screened reel separation graphics on the reel glass itself. In other words, such graphics may be incorporated on reel shroud 200, and allow reel glass 120 to be simply a clear glass. Positioning lights above and/or below the shroud to introduce light between the reel glass and the front surface of the reels through semi-transparent transfusion panels 250 allows light to enter the space between the reels and the reel glass in a manner that front-lights the reels. By way of example and not intended to be limiting in any way, it might be desirable to highlight one or more bonus reels or bonus indicia in this manner using white front light or light of a particular color. It will be obvious to one normally skilled in the art that, in order to prevent player confusion, the height and shape of separators 260 and the type of lights may be altered from the illustrated embodiment as required to prevent light bleeding onto the face of adjacent reels. Additionally, the beam of the light source may be adjusted to illuminate a specified area directly or indirectly as by reflection or refraction.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the claims.

What is claimed is:

1. A reel shroud comprising
a lattice frame sized and proportioned to overlay a set of reels, the lattice frame including
a set of ribs sized and proportioned to substantially overlay a separation between each of adjacent of the set of reels,
a securing portion for securing the reel shroud in relation to the set of reels, and
a pair of longitudinal ridges extending rearward and providing hooding to reduce light splashing from one illuminated reel location to another.

2. The reel shroud of claim 1, the lattice frame being substantially of an opaque material.

3. The reel shroud of claim 1, the lattice frame comprising a rigid plastic.

4. The reel shroud of claim 1, the lattice frame including transparent portions enabling a light source to transmit a light beam through selected portions of the reel shroud.

5. The reel shroud of claim 4, the transparent portions comprising square, rectangular, diamond, circular or other polygonal shapes.

6. The reel shroud of claim 4, the transparent portions comprising a colorless or colored transparent material.

7. The reel shroud of claim 4, the transparent portions including a set of related transparent portions, the set of related transparent portions corresponding to a wagered payline.

8. The reel shroud of claim 4, the transparent portions including pairs of transparent portions positioned on the peripheral frame and corresponding to potential paylines.

9. The reel shroud of claim 1, the set of ribs being shaped to correspond to the shape of the set of reels.

10. The reel shroud of claim 1, each of the set of ribs including rib transparent portions.

11. The reel shroud of claim 10, the rib transparent portions positioned for illumination along at least one payline.

12. The reel shroud of claim 10, the rib transparent portions positioned for illumination longitudinally along each visible payline.

13. The reel shroud of claim 1, the securing portion comprising a pair of peripheral portions extending forward for adhering, annealing, or otherwise securing to an overlaying substantially transparent protective cover.

14. The reel shroud of claim 13, the transparent protective cover comprising a reel glass or plastic.

15. The reel shroud of claim 1, the securing portion including perforations for bolting, screwing, or otherwise securing to a structure fixed in relative relation to the set of reels.

16. The reel shroud of claim 1, the set of ribs including ridges extending rearward and providing hooding to reduce light splashing from one illuminated reel location to another.

17. A method for shrouding a game display with reels, the method including the steps of:
segmenting respective of the reels, and
reducing illumination splash by hooding respective of the reels.

18. A method for shrouding a game display with reels and a plurality of indicia, the method including the steps of:
segmenting respective of the reels,
highlighting paylines by illuminating respective of the reels, and
reducing illumination splash by hooding respective of the indicia.
